(19) United States
(12) Patent Application Publication
(10) Pub. No.: US 2017/0337213 A1
(43) Pub. Date: Nov. 23, 2017

(54) METADATA REGENERATION

(71) Applicant: HEWLETT PACKARD ENTERPRISE DEVELOPMENT LP, Houston, TX (US)

(72) Inventors: John Michael Butt, Bristol (GB); Michael Rob Davis, Bristol (GB); Andrew James Todd, Bristol (GB)

(21) Appl. No.: 15/159,946

(22) Filed: May 20, 2016

(51) Int. Cl. G06F 17/30; G06F 17/27

(52) U.S. Cl. CPC G06F 17/30156; G06F 17/30371; G06F 17/2705; G06F 17/30221

(57) ABSTRACT

In some examples, a computing device comprising a processing resource and a machine-readable storage medium encoded with instructions executable by the processing resource to regenerate metadata. The machine-readable storage medium comprises instructions to detect a damaged meta file in a hierarchical distribution of metadata of a deduplication storage system, instructions to parse meta files in the hierarchical distribution of metadata and instructions to regenerate the damaged meta file based on the parsing of the meta files, wherein the damaged meta file is located in a higher hierarchy with respect to the parsed meta files in the hierarchical distribution of metadata.

### BACKGROUND

Computer systems comprise host computer device that communicate with storage devices that may store data to the storage devices and may later retrieve the data from the devices. Deduplication is a data compression technique used to eliminate duplicate copies of repeated data. Metadata provides information about user data stored in the storage devices in communication with the computer systems.

### BRIEF DESCRIPTION OF THE DRAWINGS

FIG. 1 is a block diagram of a computing device in communication with a deduplication storage according to an example of the present disclosure.

FIG. 2 is a hierarchical distribution of metadata according to an example of present disclosure.

FIG. 3 is a block diagram of a computing device in communication with a deduplication storage according to an example of the present disclosure.

FIG. 4 is a block diagram of a computing device comprising a deduplication storage according to an example of the present disclosure.

FIG. 5 and FIG. 6 are block diagrams of flow charts showing examples of instructions to regenerate metadata according to examples of the present disclosure.

FIG. 7 and FIG. 8 show examples of machine-readable storage medium to regenerate metadata according to example of the present disclosures.

### DETAILED DESCRIPTION

User data may be compressed using a technique known as deduplication. In a deduplication system or a deduplication store, a file may be read in segmented units of data and each read unit of data may be compared to previously read units. If a redundant unit is detected, the redundant unit may be replaced with a reference or pointer to the matching unit of data previously detected. The reference or pointer may be much smaller in size than a data unit, which may occur dozens, hundreds, or even thousands of times in a given file. Thus, deduplication may save a considerable amount of storage.

Metadata providing information about user data stored in storage devices in communication with computer systems may be corrupted or missed. In order to restore the corrupted or missed metadata the use of system backups may be required. A hierarchical distribution of metadata comprising a plurality of meta files having a hierarchical relation among them may permit the regeneration of a corrupted or missed meta file by analyzing the whole content of meta files within the hierarchical distribution of metadata. Hence, metadata can be restored without requiring a system backup.

In some examples described herein, a computing device may comprise a processing resource. The processing resource of the computing device may execute instructions on a machine-readable storage medium for regeneration of metadata. The processing resource may execute instructions to detect a damaged meta file in hierarchical distribution of metadata of a deduplication storage system, instructions to parse meta files in the hierarchical distribution of metadata and instructions to regenerate the damaged meta file based on the parsing of the meta files. The damaged meta file may be located in a higher hierarchy with respect to the parsed meta files in the hierarchical distribution of metadata.

In some examples, the hierarchical distribution of metadata may comprise a container index folder, the container index folder storing a plurality of container index meta files, the plurality of container index meta files referencing unique instances of user data stored in a container data storage. The hierarchical distribution of metadata may further comprise a plurality of item folders, wherein each of the item folders can reference a unique instance of user data and can comprises an item meta file, an item version folder storing a plurality of item version meta files and a segment folder storing a plurality of segment meta files.

In some examples, according to the present disclosure, the plurality of item folders, the container index folder and the container data storage can be comprised in a main storage node within the deduplication storage system, the main storage node can comprise a store meta file.

In some examples, the store meta file can reference the plurality of item folders, and wherein for each item folder of the plurality of item folders the item meta file can reference the plurality of item version meta files within the item version folder, the plurality of item version meta files can reference the plurality of segment meta files within the segment folder and the plurality of segment meta files can reference the plurality of container index meta files.

In another example, according to the present disclosure, the store meta file may be positioned or located higher in the hierarchical distribution of metadata with respect to the item meta files, the item meta files may be higher in the hierarchical distribution of metadata with respect to the item version meta files, the item version meta files may be higher in the hierarchical distribution of metadata with respect to the segment meta files and the segment meta files may be higher in the hierarchical distribution of metadata with respect to the container index meta files. Furthermore, the damaged meta file may be a missed meta file which may be associated with at least one of the store meta file, the item meta files, the item version meta files and the segment meta files. A damaged meta file can be a meta fie that cannot accessed in a normal way. A missed meta file can be a meta file that was never stored in the hierarchical distribution of metadata or a meta filed that was unexpectedly deleted. A corrupt meta file can be a meta file that suffered errors during writing, reading, storage, transmission, or processing that may introduce unintended changes to the original data.

In some examples according to the present disclosure, the damaged meta file can be the store meta file, the item meta files, the item version meta files and the segment meta files.

In some examples the computing device can further comprise instructions to detect a missed metafile in the hierarchical distribution of metadata of the deduplication storage system. Furthermore, the computing device can comprise instructions to regenerate the missed meta file based on the parsing of the meta files, wherein the missed meta file is located in a higher hierarchy with respect to the parsed meta files in the hierarchical distribution of metadata.

According to another example of the present disclosure, the computing device may further comprise the deduplication storage system. In other examples, the deduplication storage system may be located remotely with respect to the computing device. The computing device may employ communication techniques to communicate with the deduplication system. In one example, the communication techniques may include wireless cellular and non-cellular communication techniques in order to communicate with the deduplication storage remotely located.

In some examples described herein, a machine-readable storage medium may be encoded with instructions to regenerate metadata. The machine-readable storage medium may further comprise instructions to detect a missed meta file in the hierarchical distribution of metadata in the deduplication storage system, instructions to scan meta files associated with the missed meta file in the hierarchical distribution of metadata and instructions to regenerate the missed meta file based on the scanner meta files. The damaged meta file may be located in a higher hierarchy with respect to the parsed meta files in the hierarchical distribution of metadata. In some examples, the machine-readable storage medium may further comprise instructions to access an instance of user data stored in a container data storage of the deduplication storage system after restoring the missed meta file based on the regenerated meta file and the meta files in the hierarchical distribution of metadata and instructions to copy the hierarchical distribution of metadata to redundant storage nodes.

In some examples, the machine-readable storage medium can further comprise instructions to detect a damaged meta file in the hierarchical distribution of metadata in the deduplication storage system and instructions to regenerate the damaged meta file based on the scanned meta files, wherein the damaged meta file is located in a higher hierarchy with respect to the scanned meta files in the deduplication storage system of hierarchical metadata.

In some examples described herein, a method for metadata regeneration may involve detecting, by a computing device, a corrupt meta file in a hierarchical distribution of metadata of a deduplication storage system, parsing, by the computer device meta files in the hierarchical distribution of metadata and regenerating, by the computing device, the damaged meta file based on the parsing of the meta files. The damaged meta file may be located in a higher hierarchy with respect to the parsed meta files in the hierarchical distribution of metadata. In some examples, parsing meta files in the deduplication system of hierarchical metadata may further comprise accessing content of item meta files, item version meta files, segment meta files and container index meta files. In some examples according to the present disclosure, the method for metadata regeneration may further comprise accessing an instance of user data stored in a container data storage after restoring the damaged meta file based on the restored meta file and the meta files in the hierarchical distribution of metadata and copying the hierarchical distribution of metadata into a number of redundant storage nodes in the deduplication system, wherein the number of redundant storage nodes varies based on a predetermined policy. In some examples the damaged metafile may comprise a corrupt metafile or a missing metafile.

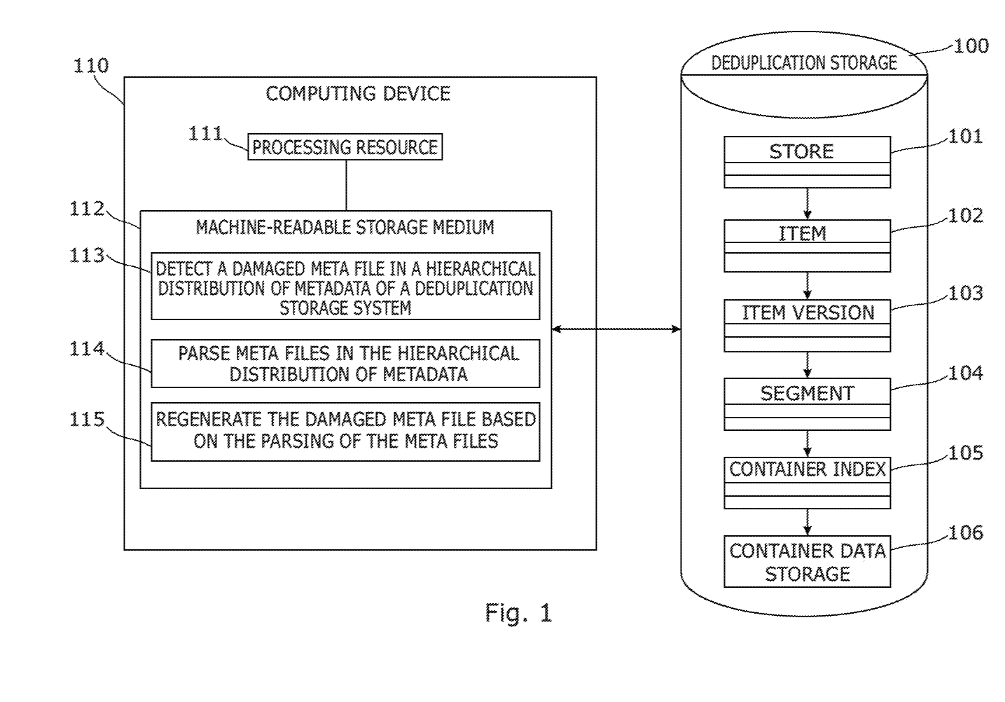

FIG. 1 illustrates a computing device 110 according to an example of the present disclosure. The computing device 110 may comprise a processing resource 111. The computing device 110 may be any networking, computing, or storage device suitable for execution of the functionality described below. As used herein, the computing device may be a desktop computer, laptop (or notebook) computer, workstation, tablet computer, mobile phone, smart device, switch, router, server, blade enclosure, or any other processing device or equipment including a processing resource. In some examples, the computing device 110 may be a controller node for a storage platform or may be located within a controller node for a storage platform.

As depicted in FIG. 1, the computing device 110 may also include a machine-readable storage medium 112 comprising (e.g., encoded with) instructions 113, 114 and 115 executable by the processing resource 111 to implement functionalities described herein in relation to FIG. 1. In particular, the storage medium 112 may include instructions 113 to detect a damaged meta file in a hierarchical distribution of metadata of a deduplication storage system 100 comprising a hierarchical distribution of metadata with elements 101, 102, 103, 104, 105 and 106. The storage 112 may include the instructions 114 to parse meta files in the hierarchical distribution of metadata and the instructions 115 to regenerate the damaged meta file based on the parsing of the meta files. The damage meta file may be located in a higher hierarchy with respect of the parsed meta files in the hierarchical distribution of metadata.

In some examples, the functionalities described herein in relation to the instructions 113, 114, 115 and any additional instructions described herein in relation to the storage medium 112, may be implemented at least in part in electronic circuitry (e.g., via components comprising any combination of hardware and programming to implement the functionalities described herein). In one example, the techniques of the present disclosure may be implemented in hardware, software or a combination thereof.

As used herein, the machine-readable storage medium may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory.

In examples described herein, a processing resource may include, for example, one processor or multiple processors included in a single device or distributed across multiple devices. As used herein, a processor may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. The processing resource 111 may fetch, decode, and execute instructions stored on the storage medium 112 to perform the functionalities described above in relation to the instructions 113, 114 and 115. In other examples, the functionalities of any of the instructions of the storage medium 112 may be implemented in the form of electronic circuitry, in the form of executable instructions encoded on a machine-readable storage medium, or a combination thereof. In the example of FIG. 1, the storage medium 112 may be implemented by one machine-readable storage medium, or multiple machine-readable storage media.

In the example of FIG. 1, the hierarchical distribution of metadata within the deduplication storage system 100 is in communication with the computing device 110 of FIG. 1. The deduplication storage system 100 may comprise a plurality of meta files 101, 102, 103, 104 and 105. Each of these meta files can be a node within the hierarchical distribution of meta data. Each of these meta files may comprise a link or pointer to the next meta file within the hierarchical distribution of meta data within the deduplication storage system 100 in such a way that the store meta file 101 can specify whether a single instance of user data, i.e. a file of user data is stored in the container data storage 106. The item meta file 102 may represent the file of user data being verified and the item version meta file 103 may represent a version of the file of user data represented by the item meta file 102. Thus, there may be an item version file for each version of the instance of user data represented by the item meta file 102. The item meta file 102 may be associated with metadata of the file of user data and each item version meta file 103 may be associated with metadata of each version of the file of user data.

The segment meta file 104 may contain the location and the size of a given unit of data in the file of user data. The size of the unit of user data represented by segment meta file 104 may be any size, such as, for example, 5 Mb. In one example, there may be a segment meta file for each single occurrence of a unit of user data detected in the file or in any of its versions. By way of example, if File A has three different versions and data unit “ABC” may occur three times in the first version, three times in the second version, and twice in the third version there may still be only one segment meta file for user data unit “ABC” instead of eight. The container index meta file 105 may be another intermediate meta file within the hierarchical structure of metadata within the deduplication storage system 100 associated with metadata of at least one deduplication reference or pointer associated with the file of user data being verified. The container index meta file 105 may include a deduplication reference for an instance of user data represented by the segment meta file 104. The container index meta file 105 may also comprise a count of how many times the instance of user data may occur in the file and in which versions they occur. Referring back to the example above, the container index meta file 105 may indicate that the instance of user data “ABC” may occur eight times (three times in the first version, three times in the second version, and twice in the third). Finally, the container data storage 106 may be a leaf storage of container data files representing unique instances of user data.

Hence, the hierarchical distribution of meta data can provide means of navigating to container data files comprised in the container data storage 106. The container data files can be single instances of user data implemented as single files. Hence, the container data files can hold user data. Each item meta file 102, item version meta file 103 and the segment meta file 104 can be unique to a single instance of user data, i.e. they can be understood as a virtual tape cartridge. The store where the container index meta file 105 can be stored and the container data storage 106 may be shared between many instances of user data.

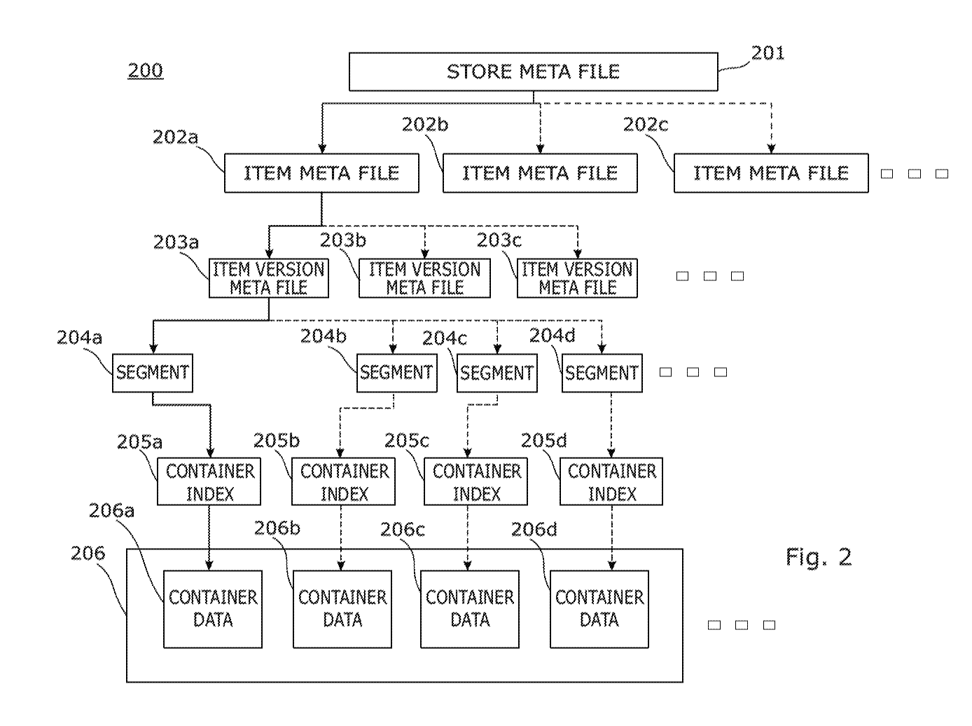

Referring now to FIG. 2, a more detailed depiction of the example of hierarchical distribution metadata 200 is shown. This hierarchical distribution may comprise a store meta file 201 referencing a plurality of item meta files 202a, 202b and 202c. Each of the plurality of item meta files may refer to one or more item version meta files. In this particular example according to the present disclosure, the item meta file 202a can refer to item version meta files 203a, 203b and 203c. Item version meta file 203a can refer to a plurality of segment meta files. In particular, item version meta file 203a can refer to segment meta files 204a, 204b, 204c and 204d. In this particular example, each of the segment meta files can refer to a container index meta file. In particular, the segment meta file 204a can refer to a container index meta file 205a, the segment meta file 204b can refer to the container index meta file 205b, the segment meta file 204c can refer to the container index meta file 205c and the segment meta file 204d can refer to the container index meta file 205d. The container index meta files 205a, 205b, 205c and 205d can refer to container data files 206a, 206b, 206c and 206d, respectively. Each of the container data files within the container data storage 206 can represent unique instances of user data store within the container data storage 206.

Table 1 shows an example of a deduplication store as part of a deduplication storage system according to the present disclosure that shows the hierarchical distribution of meta files organized in folders associated with the meta files:

TABLE 1

```
Deduplication store
|----store meta file
|----main item folder
    |---- item folder 1
        |----item 1 meta file
        |----item version 1 folder
            |----item version 1 meta file
        |----segment folder
            |----segment meta file
    |----item folder 2
        |----item 2 meta file
        |----item version 1 folder
            |----item version 1 meta file
        |----segment folder
            |----segment meta file
    |----item folder 3
        |----item 3 meta file
        |----item version 1 folder
            |----item version 1 meta file
        |----segment folder
            |----segment meta file
    |----item folder 4
        |----item 4 meta file
        |----item version 1 folder
            |----item version 1 meta file
        |----segment folder
            |----segment meta file
    |----item folder 5
        |----item 5 meta file
        |----item version 1 folder
            |----item version 1 meta file
        |----segment folder
            |----segment meta file
    |----item folder 6
        |----item 6 meta file
        |----item version 1 folder
            |----item version 1 meta file
        |----segment folder
            |----segment meta file
    |----container index folder
        |----container index meta file
    |---- container data storage
        |----- container data file
```

Table 1 shows a deduplication store in a deduplication system according to an example of the present disclosure. The deduplication store can store the hierarchical distribution of metadata. The deduplication store can comprise a store meta file and a main item folder storing six item folders. The item folder X comprises an item X meta file (where X=1, 2, 3, 4, 5 or 6), (the item X meta file can correspond to the item meta file 102 shown in FIG. 1), an item version 1 folder storing an item version 1 meta file (the item version 1 meta file can correspond to the item version meta file 103 shown in FIG. 1) and a segment folder storing a segment meta file (the segment meta file can correspond to the segment meta file 104 shown in FIG. 1).

Table 1 shows that the store further comprises a container index folder storing a container index meta file (container index meta file 105 as shown in FIG. 1) and a container data storage storing a container data file that can represent a unique instance of user data as shown in FIG. 1.

Table 1 shows the data organized in the hierarchical distribution of metadata according to the present disclosure. In one example according to the present disclosure shown in Table 1, the data contained in the item folders X can be mapped to a total of six instances of user data associated with three different users. In this particular example, three instances of user data from user A can be mapped to item folders 1, 2 and 3. Two instances of user data from user B can be mapped to item folders 4 and 5 and one instance of user data from user C can be mapped to item folder 6. The item version 1 and the segment folders and their corresponding meta files, i.e. item version 1 and segment meta filed can be unique per item folder.

The container index folder and container data folder can contain user files that can be shared across all items folders X within the deduplication store, that is, the files that are not unique to a single item folder X. Hence, only a single copy of a user instance, i.e. a single or unique instance of user data shared across all items folders X can be stored in the container data folder. Hence, if an instance of user data (e.g. email advertising sales from a store) is shared by user A, user B and user C, i.e. shared instance of user data mapped to item folder 1 for user A, to item folder 3 for user B and to item folder 6 for user C, a unique version of this instance of user data shared among all users may be stored in the container data folder of the deduplication store shown in Table 1.

Table 2 shows how an instance “z” of user data that was previously backed up to a specific item folder X, e.g. item folder 2 can be accessed. In order to recover the instance “z” of user data, the following meta data within the hierarchical distribution of meta data can be read when accessing the deduplication store shown in Table 1:

TABLE 2

| | |
|---|---|
| 1. | Read the store meta file to check item folder 2 exists; |
| 2. | Read item 2 meta file within the item folder 2 to ascertain which |
| | item version meta file to read; |
| 3. | Read the item version meta file to ascertain which segment meta |
| | file to read; |
| 4. | Read the segment meta file to ascertain which container index |
| | meta file to read; |
| 5. | Read the container index meta file to ascertain which container |
| | data file to read; |
| 6. | Read the container data file that contains the data making up |
| | the instance “z” of user data. |

In one example, the present techniques provide a hierarchy to the meta data within the hierarchical distribution shown in Table 1. To access data in the container data storage, the meta data files within the hierarchical distribution may be accessed. The present disclosure presents a solution for events where any one of the meta data files is missing or corrupt. In one example, computing device 110 may be configured to practice the techniques of the present disclosure.

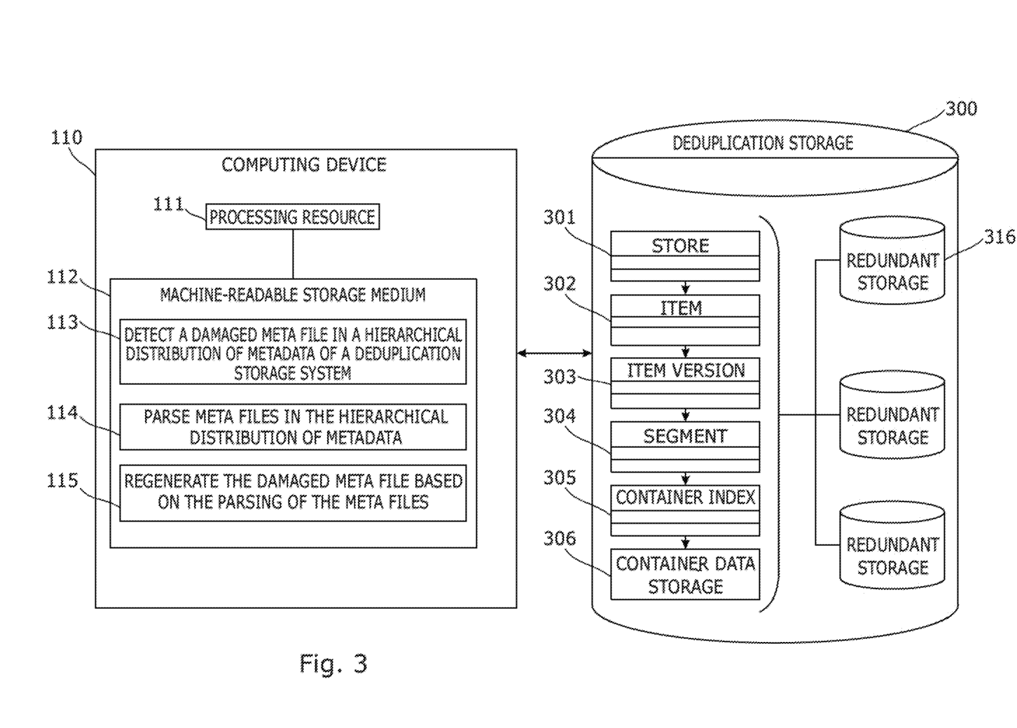

FIG. 3 shows the computing device 110 comprising the machine-readable storage medium 112 shown in previous FIG. 1 comprising (e.g., encoded with) the instructions 113, 114 and 115 executable by the processing resource 111 to regenerate metadata associated with a deduplication storage system 300. The computing device 110 can communicate with the deduplication storage system 300 comprising a hierarchical distribution of metadata (301, 302, 303, 304, 305 and 306). The duplication storage system 300 of this particular example may further comprise a plurality of redundant storage nodes 316. In this example, the deduplication storage system 300 can comprise three redundant storage nodes 316. The number or redundant storage nodes 316 can be modified based on a predetermined policy or on a previously agreed quality of service. In the distributed deduplication system 300, user data can be written to multiple storage nodes. Similarly, copying metadata across one or more storage nodes (i.e. redundant storage 316) can remove a single point of failure thus improving the system robustness.

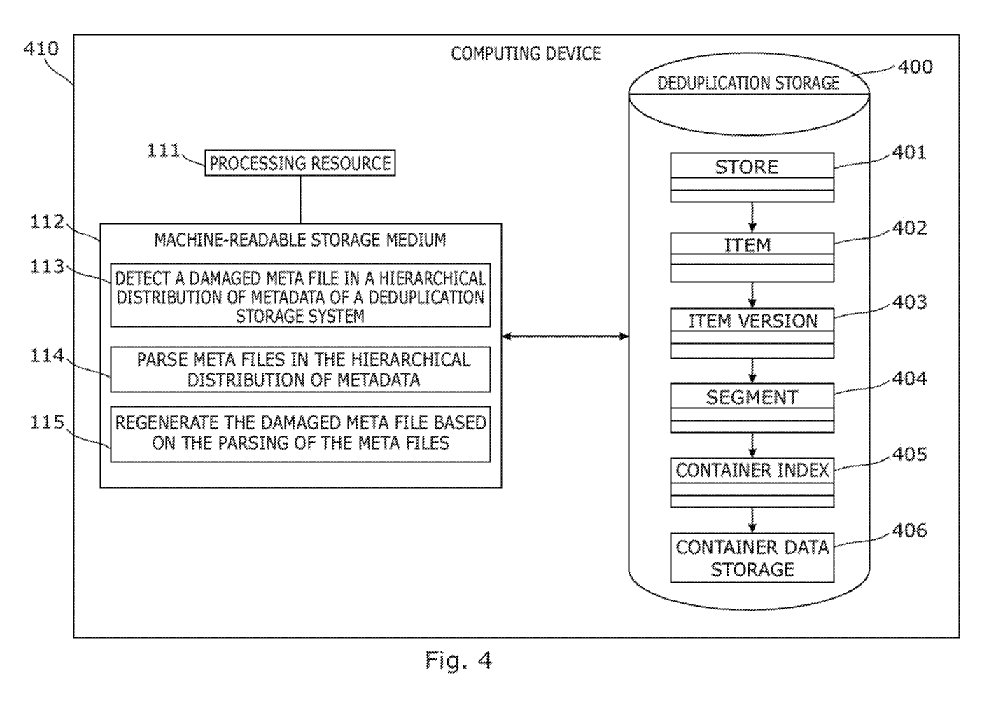

FIG. 4 shows a computing device 410 according to an example of the present disclosure. The computing device 410 can comprise the machine-readable storage medium 112 shown in previous FIG. 1 comprising (e.g., encoded with) the instructions 113, 114 and 115 executable by the processing resource 111 to implement regeneration of meta data. Furthermore, in this example according to the present disclosure the computing device 410 can comprise a deduplication storage system 400 having a hierarchical distribution of metadata (401, 402, 403, 404, 405 and 406) and integrated in the computing device 410.

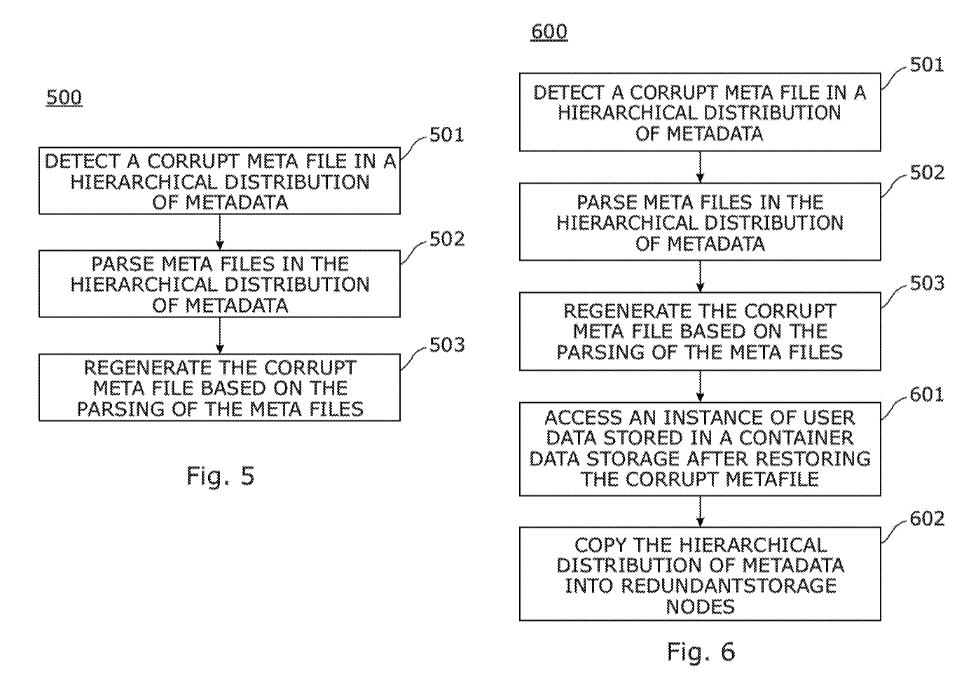

FIG. 5 shows a block diagram 500 of a flow chart according to an example of the present disclosure for metadata regeneration than can be performed by a computing device. In one example, computing device 110 of FIG. 1 may be configured to practice the process of diagram 500. In particular, the diagram 500 comprises a block 501 which includes computing device configured to detect a corrupt meta file in a hierarchical distribution of metadata of a deduplication storage system. The hierarchical distribution of metadata in the deduplication storage system can comprise a container index folder, the container index folder may store a plurality of container index meta files and the plurality of container index meta files can reference unique instances of user data stored in a container data storage.

The hierarchical distribution of metadata in the deduplication storage system can further comprise a plurality of item folders, wherein each of the item folders can reference a unique instance of user data and comprise an item meta file, an item version folder storing a plurality of item version meta files and a segment folder storing a plurality of segment meta files. In this particular example according to the present disclosure, the plurality of item folders, the container index folder and the container data storage can be comprised in a main storage node or deduplication store, the main storage node can comprise a store meta file.

The store meta file can reference the plurality of item folders, and wherein for each item folder of the plurality of item folders the item meta file can reference the plurality of item version meta files within the item version folder, the plurality of item version meta files can reference the plurality of segment meta files within the segment folder and the plurality of segment meta files can reference the plurality of container index meta files.

The store meta file can be higher in the hierarchical distribution of metadata with respect to the item meta files. The item meta files can be higher in the hierarchical distribution of metadata with respect to the item version meta files. The item version meta files can be higher in the hierarchical distribution of metadata with respect to the segment meta files and the segment meta files can be higher in the hierarchical distribution of metadata with respect to the container index meta files. The corrupt meta file can be a missed meta file related to the store meta files, the item meta files, the item version meta files and the segment meta files.

In block 502 the meta files within the hierarchical distribution of meta data can be parsed. In one example, computing device 110 may parsing meta files in the hierarchical distribution of metadata in the deduplication system can comprise accessing, reading, analyzing or scanning the content of the item meta files, the item version meta files, the segment meta files and/or the container index meta files.

In block 503, computing device may regenerate the corrupt meta file based on the parsing of the meta files, wherein the corrupt meta file can be located in a higher hierarchy with respect to the parsed meta files in the hierarchical distribution of metadata. The example according to the present disclosure may enable “parent” meta data (i.e. metadata in a higher hierarchy in the hierarchical distribution of meta data) to be rebuilt from “child” meta data (i.e. meta data in a lower hierarchy in the hierarchical distribution of meta data).

In a particular example according to the present disclosure, in the case that a store meta data file is corrupt, it may be regenerated by scanning all available item meta files, where the item meta files may be in a lower hierarchy with respect to the store meta file. Hence, in the case the store metadata file is corrupt, item folders can be accessed and the item data files contained in those folders can be read or scanned. The data contained in the item folders can be used to produce or regenerate a new uncorrupted store meta data file. This method of regeneration of meta data can be used for all types of meta data files within the deduplication system, thus providing a means of increased filed corruption robustness.

It should be understood that block diagram 500 is an example flow chart and that other example flow charts or processes may be employed to practice the present techniques.

FIG. 6 shows a block diagram 600 of a flow chart to practice the present techniques and comprises the previously mentioned blocks 501, 502 and 503 and additional blocks 601 and 602. In particular, in block 601 an instance of user data stored in a container data storage of the deduplication storage system can be accessed by computer device 110 after restoring the corrupt meta file based on the restored meta file and the existing meta files in the hierarchical distribution of metadata. The container data storage may hence, by performing the previous blocks 501, 502 and 503, corrupted meta data can be restored and the instances of user data stored in the container data storage can be accessed.

In block 602, computing device 110 may copy the hierarchical distribution of metadata into a number of redundant storage nodes in the deduplication system, wherein the number of redundant storage nodes can be modified based on a predetermined policy or on a previously agreed quality of service. In a distributed deduplication system, user data can be written to multiple storage nodes. Copying metadata across one or more storage nodes may remove a single point of failure thus improving system robustness.

User based policies could be implemented to determine how many nodes metadata can be copied to. For example, for ultimate robustness, a metadata could be copied to all nodes in the deduplication system. A user may choose to trade additional storage requirements for multi node metadata storage versus improved robustness.

It should be understood that block diagram 600 is an example flow chart and that other example flow charts or processes may be employed to practice the present techniques.

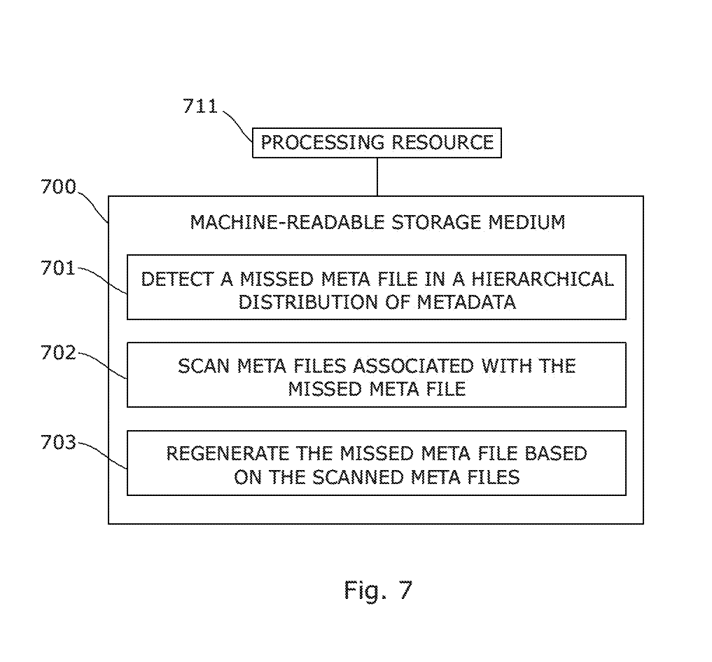

FIG. 7 shows a block diagram of an example of a machine-readable storage medium 700 according to an example of the present disclosure. The storage medium 700 can include instructions executable by a processing resource 711. In particular, the storage medium 700 can comprise instructions 701 to detect a missed meta file in a hierarchical distribution of metadata in a deduplication system, instructions 702 to scan meta files associated with the missed meta file in the hierarchical distribution of metadata and instructions 703 to regenerate the missed meta file based on the scanned meta files. The missed meta file can be located in a higher hierarchy with respect to the scanned meta files in the deduplication storage system of hierarchical metadata. An example of a hierarchical distribution metadata has been described in previous figures. The missed meta file can be a file associated with a store meta file, item meta files, item version meta files and segment meta files within the hierarchical distribution of metadata. The processing resource 711 and the storage medium 700 may be part of a computing device as previously described in the present disclosure that can additionally include the deduplication storage system. In another example according to the present disclosure, the deduplication storage system can be located remotely with respect to the computing device comprising the processing resource 711 and the storage medium 700.

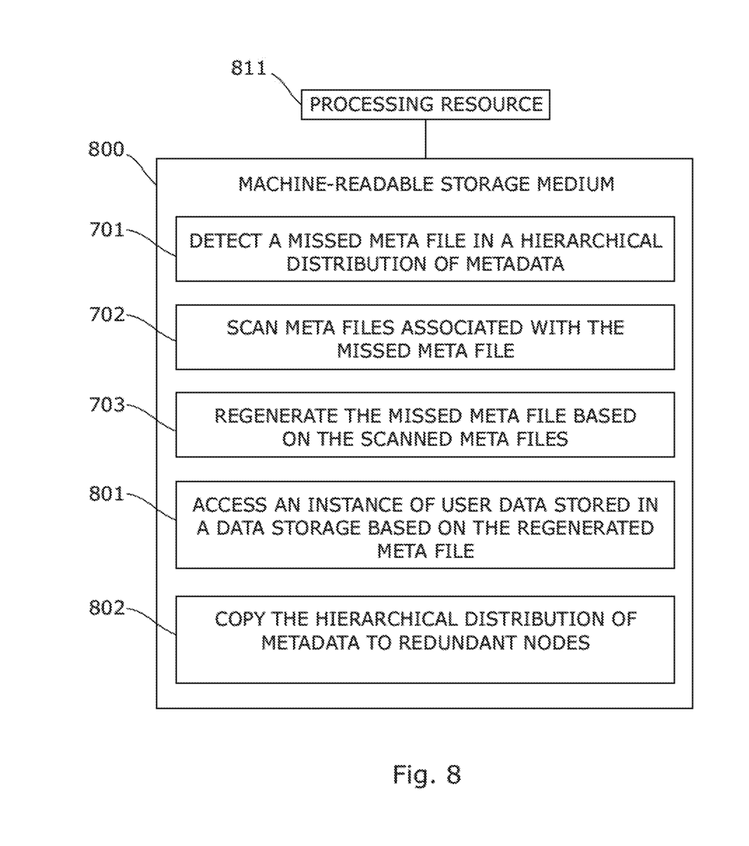

FIG. 8 shows a block diagram of an example of a machine-readable storage medium 800 according to an example of the present disclosure. The storage medium 800 can include instructions executable by a processing resource 811. In particular, the storage medium 800 can comprise the instructions previously shown in FIG. 7. In particular the storage medium 800 can comprises instructions 701, 702 and 703. Furthermore, the storage medium 800 can comprise instructions 801 to access an instance of user data stored in a container data storage of the deduplication storage system after regenerating the missed meta file. Accessing an instance of user data according to instructions 801 may be based on the regenerated meta file and the meta files in the hierarchical distribution of metadata. Furthermore, the storage medium 800 can further comprise instructions to copy the hierarchical distribution of metadata to redundant storage nodes. The processing resource 811 and the storage medium 800 may be comprised within a computing device as previously described and shown figures. The deduplication store comprising the hierarchical distribution of metadata may be part of the computing device. In other examples according to the present disclosure, the deduplication storage may be comprised in a second computing device remotely located and in communication with the computing device.

In one example, regeneration of meta data in a hierarchical distribution of metadata in a deduplication system has been described in the present disclosure.

What is claimed is:

1. A computing device comprising:
a processing resource; and
a machine-readable storage medium encoded with instructions executable by the processing resource to regenerate metadata, the machine-readable storage medium comprising:
instructions to detect a damaged meta file in a hierarchical distribution of metadata of a deduplication storage system;
instructions to parse meta files in the hierarchical distribution of metadata; and
instructions to regenerate the damaged meta file based on the parsing of the meta files, wherein the damaged meta file is located in a higher hierarchy with respect to the parsed meta files in the hierarchical distribution of metadata.

2. The computing device of claim 1, wherein the hierarchical distribution of metadata comprises a container index folder, the container index folder storing a plurality of container index meta files, the plurality of container index meta files referencing unique instances of user data stored in a container data storage.

3. The computing device of claim 2, wherein the hierarchical distribution of metadata further comprises a plurality of item folders, wherein each of the item folders references a unique instance of user data and comprises:
an item meta file;
an item version folder storing a plurality of item version meta files; and
a segment folder storing a plurality of segment meta files.

4. The computing device of claim 3, wherein the plurality of item folders, the container index folder and the container data storage are comprised in a main storage node within the deduplication storage system, the main storage node comprising a store meta file.

5. The computing device of claim 4, wherein the store meta file references the plurality of item folders, and wherein for each item folder of the plurality of item folders:
the item meta file references the plurality of item version meta files within the item version folder,
the plurality of item version meta files reference the plurality of segment meta files within the segment folder, and
the plurality of segment meta files reference the plurality of container index meta files.

6. The computing device of claim 5, wherein:
the store meta file is higher in the hierarchical distribution of metadata with respect to the item meta files;
the item meta files are higher in the hierarchical distribution of metadata with respect to the item version meta files;
the item version meta files are higher in the hierarchical distribution of metadata with respect to the segment meta files; and
the segment meta files are higher in the hierarchical distribution of metadata with respect to the container index meta files.

7. The computing device of claim 1, wherein the damaged meta file is at least one of the following:
the store meta file;
the item meta files;
the item version meta files; and
the segment meta files.

8. The computing device of claim 1, further comprising instructions to detect a missed metafile in the hierarchical distribution of metadata of the deduplication storage system.

9. The computing device of claim 8, further comprising instructions to regenerate the missed meta file based on the parsing of the meta files, wherein the missed meta file is located in a higher hierarchy with respect to the parsed meta files in the hierarchical distribution of metadata.

10. The computing device of claim 1, further comprising the deduplication storage system.

11. A machine-readable storage medium encoded with instructions executable by a processing resource to regenerate metadata, the machine-readable storage medium comprising:
instructions to detect a missed meta file in a hierarchical distribution of metadata in a deduplication storage system;
instructions to scan meta files associated with the missed meta file in the hierarchical distribution of metadata; and
instructions to regenerate the missed meta file based on the scanned meta files, wherein the missed meta file is located in a higher hierarchy with respect to the scanned meta files in the deduplication storage system of hierarchical metadata.

12. The machine-readable storage medium of claim 11, further comprising:
instructions to access an instance of user data stored in a container data storage of the deduplication storage system after regenerating the missed meta file based on:
the regenerated meta file; and
the meta files in the hierarchical distribution of metadata.

13. The machine-readable storage medium of claim 11, further comprising:
instructions to copy the hierarchical distribution of metadata to redundant storage nodes.

14. The machine-readable storage medium of claim 11, further comprising:
instructions to detect a damaged meta file in the hierarchical distribution of metadata in the deduplication storage system.

15. The machine-readable storage medium of claim 11, further comprising:
instructions to regenerate the damaged meta file based on the scanned meta files, wherein the damaged meta file is located in a higher hierarchy with respect to the scanned meta files in the deduplication storage system of hierarchical metadata.

16. A method for metadata regeneration comprising:
detecting, by a computing device, a corrupt meta file in a hierarchical distribution of metadata of a deduplication storage system;
parsing, by the computer device meta files in the hierarchical distribution of metadata; and
regenerating, by the computing device, the corrupt meta file based on the parsing of the meta files, wherein the corrupt meta file is located in a higher hierarchy with respect to the parsed meta files in the hierarchical distribution of metadata.

17. The method of claim 16, wherein parsing meta files in the deduplication system of hierarchical metadata further comprises:
accessing content of:
item meta files;
item version meta files;
segment meta files; and
container index meta files.

18. The method of claim 16, further comprising:
accessing an instance of user data stored in a container data storage of the deduplication storage system after restoring the damaged meta file based on:
the restored meta file; and
the meta files in the hierarchical distribution of metadata.

19. The method of claim 16, further comprising:
copying the hierarchical distribution of metadata into a number of redundant storage nodes in the deduplication system, wherein the number of redundant storage nodes varies based on a predetermined policy.

20. The method of claim 16, further comprising:
determining the corrupt metafile as a missed metafile.
